(19) United States
(12) Patent Application Publication
(10) Pub. No.: US 2019/0298106 A1
(43) Pub. Date: Oct. 3, 2019

(54) AN AIR-BASED COOKER

(71) Applicant: KONINKLIJKE PHILIPS N.V., EINDHOVEN (NL)

(72) Inventor: FILIP PAWEL CICHOSZ, EINDHOVEN (NL)

(73) Assignee: KONINKLIJKE PHILIPS N.V., EINDHOVEN (NL)

(21) Appl. No.: 16/307,978

(22) PCT Filed: Jun. 1, 2017
(86) PCT No.: PCT/EP2017/063256

§ 371 Date: Dec. 7, 2018

(30) Foreign Application Priority Data
Jun. 14, 2016 (EP) 16174430.5

(51) Int. Cl. A47J 37/06

(52) U.S. Cl. CPC A47J 37/0641

(57) ABSTRACT

The present application relates to an air-based cooker (1) comprising a cooking chamber (20); a heater (19) for heating air in the cooking chamber; a fan (18) for circulating a flow of heated air in the cooking chamber; an exhaust device (23) for directing a volume of heated air out of the cooking chamber. The exhaust device comprises an arcuately shaped duct (29) having an outer peripheral wall (30) and an inner peripheral wall (31), the duct including an inlet (32) communicating with the cooking chamber; a first outlet (33) to the cooking chamber; a second outlet (34) facing substantially upwardly and through which the volume of heated air flows to exit the cooker. The duct is configured such that a centrifugal force is applied to particles contained in the air flowing through the duct to limit the amount of particles flowing through the second outlet and exiting the cooker.

### FIELD OF THE INVENTION

The present invention relates to an air-based cooker. The present invention also relates to an exhaust device for use in an air-based cooker.

### BACKGROUND OF THE INVENTION

An air-based cooker uses heated air accelerated to a high velocity to cook food. The high velocity air causes a high rate of heat transfer from the air to the food relative to a typical fan oven. A particular feature of an air-based cooker is that it circulates air around the food to evenly heat the food from all sides. This produces results not dissimilar to pan frying or deep frying but with substantially less fat content in the food as little or no oil is required.

A conventional air-based cooker comprises a cooking chamber having an exhaust outlet for the heated air flow to exit the cooker, in order to ensure that the cooking chamber is kept at near constant pressure during the cooking process. One problem is that the air flow exiting the cooker through the exhaust outlet may contain food and/or oil particles that may get out of the cooker and pollute the external housing and/or the surroundings of the cooker.

EP 1 867 929 discloses an oven having a steam generator generating steam, and a cooking cavity for receiving food to be heated by the steam. The oven has a ventillation system.

### SUMMARY OF THE INVENTION

It is an object of the invention to provide an air-based cooker which substantially alleviates or overcomes one or more of the problems mentioned above.

The invention is defined by the claims.

According to the present invention, there is provided an air-based cooker comprising a cooking chamber; a heater for heating air in the cooking chamber, a fan for circulating a flow of heated air in the cooking chamber; an exhaust device for directing a volume of heated air out of the cooking chamber, the exhaust device comprising an arcuately shaped duct having an outer peripheral wall and an inner peripheral wall, the duct including an inlet communicating with the cooking chamber; a first outlet to the cooking chamber, a second outlet, preferably facing substantially upwardly and transversely to the duct, and through which, in use, the volume of heated air flows to exit the cooker; the duct being configured such that, in use, a centrifugal force is applied to solid and/or liquid particles contained in the heated air flowing through the duct such that they are deviated and forced by the flow around the duct (29) towards the outer peripheral wall, such as to limit the amount of solid and/or liquid particles flowing through the second outlet and exiting the cooker.

The exhaust device is configured to direct a volume of heated air out of the cooking chamber so that a volume of heated air exits the cooker. The exhaust device thereby ensures that the cooking chamber is kept at near constant pressure during operation of the cooker. By directing the volume of heated air out of the cooking chamber, the exhaust device also helps to reduce humidity formed in the cooking chamber. The arcuate shape of the duct results in a centrifugal force being applied to solid and/or liquid particles contained in the air flowing through the duct such that these solid and/or liquid particles are deviated and forced towards the outer peripheral wall of the duct. In this way, the amount of solid and/or liquid particles flowing through the second outlet and exiting the cooker is reduced and pollution of the external housing and/or the surroundings of the cooker by such particles is reduced.

The exhaust device may be arranged such that, in use, solid and/or liquid particles contained in the heated air flowing through the duct are redirected towards the cooking chamber through the first outlet. Solid and/or liquid particles are therefore prevented from exiting the cooking chamber. This provides the advantage that the cooker does not require any additional part for receiving solid and/or liquid particles flowing out of the cooking chamber. This also facilitates the cleaning of the cooker.

The duct may comprise a third outlet facing substantially downwardly and through which, in use, at least some of the solid and/or liquid particles contained in the heated air flowing through the duct are drawn by gravity. This reduces the number of solid and/or liquid particles in the air flowing through the duct and so limits the amount of solid and/or liquid particles exiting the cooker through the second outlet.

The cooker may comprise a receptacle for receiving solid and/or liquid particles flowing through the third outlet. This ensures that the solid and/or liquid particles flowing through the third outlet are received in a dedicated space in the cooker.

The receptacle may be removable from the cooker. This has the advantage that a user can take the receptacle out of the cooker to empty the receptacle from solid and/or liquid particles received in the receptacle and/or to clean the receptacle easily.

The air-based cooker may comprise a restriction in the second outlet adapted to further limit the amount of solid and/or liquid particles flowing out of the cooker through the second outlet.

The restriction may comprise one or more baffles located in the second outlet. The one or more baffles help to further reduce the amount of solid and/or liquid particles exiting the cooker.

The air-based cooker may comprise two baffles spaced from each other in offset relation in the second outlet. This configuration ensures that the amount of particles exiting the second outlet is limited whilst letting the air flow through the second outlet.

The second outlet may extend substantially upwardly from the inner peripheral wall of the duct. This configuration allows to further limit the amount of solid and/or liquid particles flowing out of the cooker.

The second outlet may extend substantially upwardly from the outer peripheral wall of the duct. This provides the advantage of having an exhaust device of simple design.

The exhaust device and the fan may be located relative to each other so that the fan generates an airflow through the duct. This ensures that a volume of air circulating in the cooking chamber is directed towards the exhaust device.

According to a further aspect of the present invention, there is provided an exhaust device for directing a volume of heated air out of an air-based cooker, the exhaust device comprising a generally arcuately shaped duct having an outer peripheral wall and an inner peripheral wall, the exhaust device including an inlet; a first outlet; a second outlet, preferably facing substantially upwardly and transversely to the duct, and through which, in use, the volume of heated air flows to exit the cooker; the duct being configured such that, in use, a centrifugal force is applied to solid and/or liquid particles contained in the heated air flowing through the duct such that they are deviated and forced by the flow around the duct (29) towards the outer peripheral wall, such as to limit the amount of solid and/or liquid particles flowing through the second outlet.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawings, in which:

FIG. 1 shows a cross-sectional schematic view of an air-based cooker according to the present invention;

FIG. 2 shows a schematic view of a portion of the air-based cooker according to the present invention;

FIG. 3 shows a perspective view of an exhaust device according to a first embodiment of the present invention;

FIG. 4 shows a front view of the exhaust device of FIG. 3;

FIG. 5 shows a side view of the exhaust device of FIG. 3;

FIG. 6 shows a cross-sectional view of the exhaust device of FIG. 3 taken along the line B-B shown in FIG. 4;

FIG. 7 shows a top view of the exhaust device of FIG. 3;

FIG. 8 shows a cross-sectional view of the exhaust device of FIG. 3 taken along the line D-D shown in FIG. 4;

FIG. 9 shows a bottom view of the exhaust device of FIG. 3;

FIG. 10 shows a cross-sectional view of an exhaust device according to a variant of the first embodiment of the present invention;

FIG. 11A shows a front view of an exhaust device according to a second embodiment of the present invention; and

FIG. 11B shows a side view of the exhaust device of FIG. 11A.

### DETAILED DESCRIPTION OF THE EMBODIMENTS

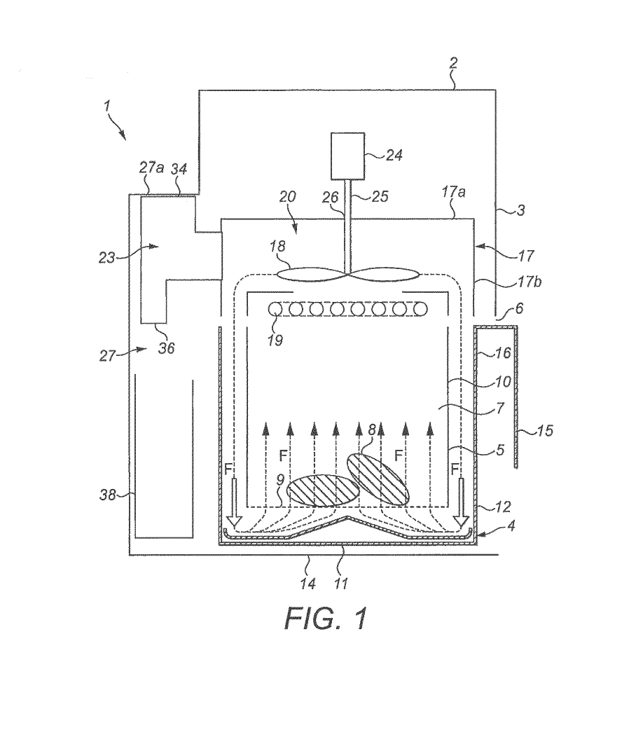

Referring to FIG. 1, a cross-sectional schematic view of an air-frying cooker 1 in accordance with the present invention is shown. The air-frying cooker 1 comprises a housing 2 having a wall 3 that defines sides of the housing 2.

Throughout this description, terms such as ‘upper’, ‘lower’, ‘upwardly’, ‘downwardly’ and so on relate to the orientation of the cooker 1 as shown in FIG. 1.

The air-frying cooker 1 further comprises an outer pan 4 and a food container or basket 5. The food container 5 is received within the outer pan 4 and both are received within the housing 2 through an opening 6 provided in the wall 3 of the housing 2.

The food container 5 has a bottom wall 9 and a sidewall 10 that define a food receiving space 7 into which food ingredients 8 to be cooked are placed prior to cooking. The bottom wall 9 is fluid, i.e. gas and liquid, permeable. For example, the bottom wall 9 may comprise a plurality of openings (illustrated by a horizontal dashed segment in FIG. 1). The bottom wall 9 may be made from, for example, a wire mesh.

The outer pan 4 comprises a base 11 and a wall 12 extending from the base 11 to provide a space for receiving the food container 5. The outer pan 4 is bigger in every dimension than the food container 5 and the food container 5 is supported above the base 11 on supports (not shown) to provide space respectively between the bottom wall 9 and the base 11 and between the sidewall 10 and the wall 12.

The outer pan 4 and the food container 5 are removable from the housing 2 through the opening 6 in the housing 2. The outer pan 4 and the food container 5 may be removable by a sliding action. For example, the base 11 of the outer pan 4 may rest on a base part 14 of the housing 2 and slide along the base part 14 during the removal of the outer pan 4 from the housing 2. A handle 15 is provided on a portion 16 of the wall 12 so that a user can slide the outer pan 4 in and out through the opening 6 as required.

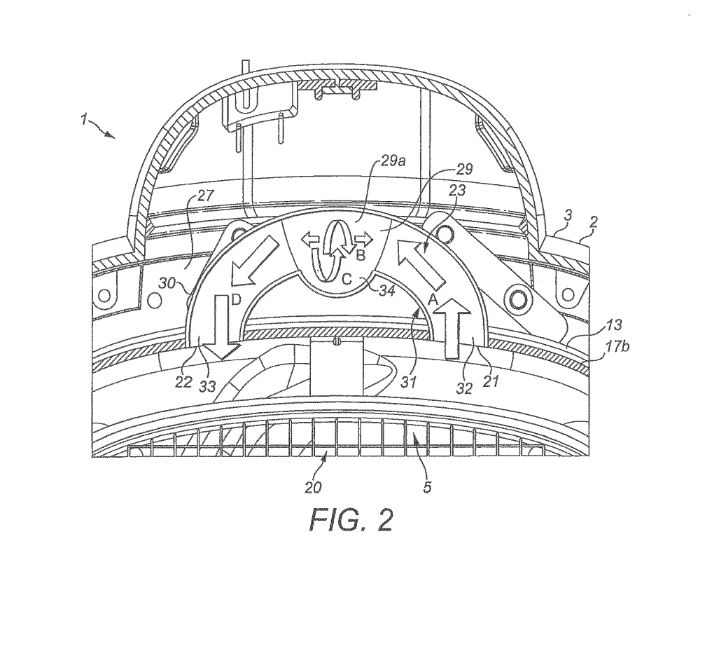

An upper enclosure 17 is provided within the housing 2 and includes a top wall 17a and a lateral wall 17b. The upper enclosure 17 is arranged around a fan 18 for circulating air and a heater 19 for heating the air as the air is circulated. When the outer pan 4 is disposed within the housing 2, the outer pan 4 locates beneath the upper enclosure 17 so that the lateral wall 17b extends above the wall 12 of the outer pan 4. The outer pan 4 and the upper enclosure 17 form together a cooking chamber 20 in which air is circulated by the fan 18 during operation of the cooker 1. A cooling channel 13 (shown in FIG. 2) is provided around the cooking chamber 20 to reduce the heat transfer from the cooking chamber 20 to the outside of the cooker 1.

A first aperture 21 (see FIG. 2) through which air can flow out of the cooking chamber 20 is provided in the lateral wall 17b of the upper enclosure 17. The lateral wall 17b also includes a second aperture 22 through which air can flow into the cooking chamber 20. The first aperture 21 is located proximate the second aperture 22. As will be explained in more detail below, the first and second apertures 21, 22 are connected to an exhaust device 23 configured to direct a volume of heated air out of the cooker 1.

The fan 18 is mechanically coupled to an electric motor 24 disposed externally to the cooking chamber 20. The fan 18 and the electric motor 24 are connected to each other by means of a drive shaft 25 which extends through an opening 26 in the upper enclosure 17.

The cooker 1 further comprises an outer compartment 27 defined by the wall 12 of the outer pan 4, the lateral wall 17a of the upper enclosure 17 and the wall 3 of the housing 2. The outer compartment 27 includes an exhaust outlet 27a including an exhaust grille (not shown) through which the volume of heated air can flow to exit the cooker 1. A filter (not shown) may be provided on the exhaust grille to filter the air exiting the cooker 1.

The exhaust device 23 is located in the outer compartment 27. The exhaust device 23 is mounted to the cooling channel 13 (as visible in FIG. 2) in the outer compartment 27. The exhaust device 23 is disposed relative to the fan 18 so that the fan 18 generates an airflow through the exhaust device 23.

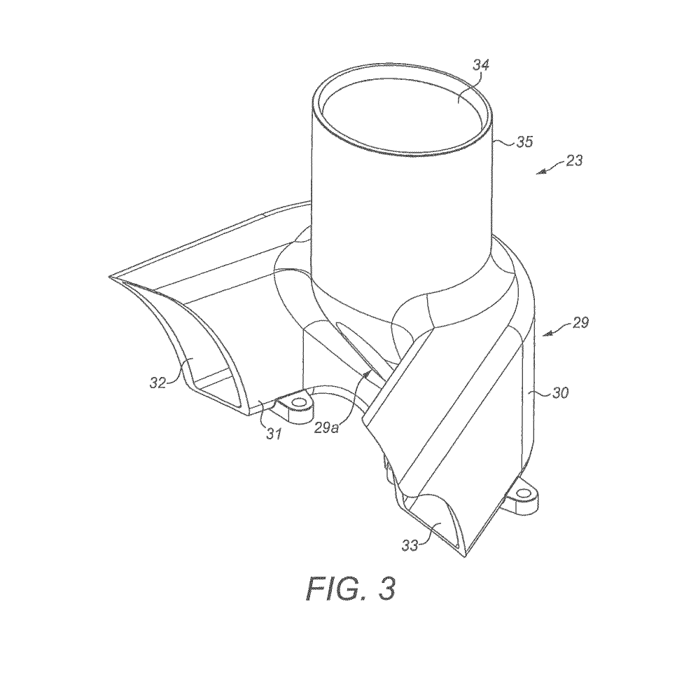

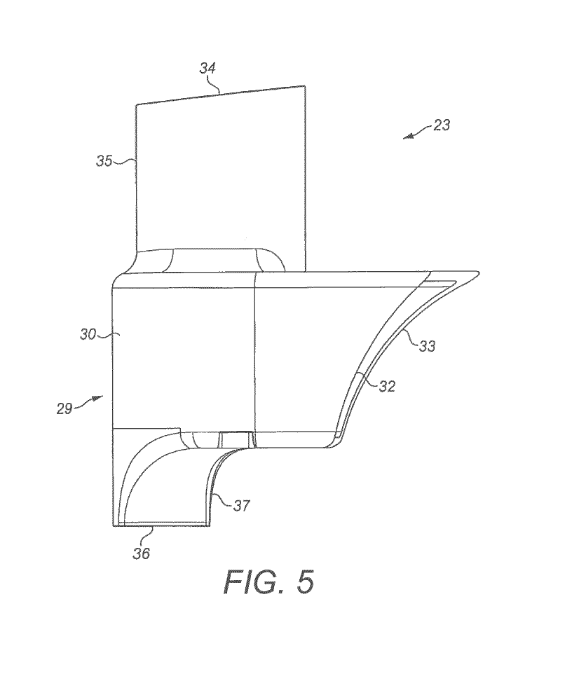

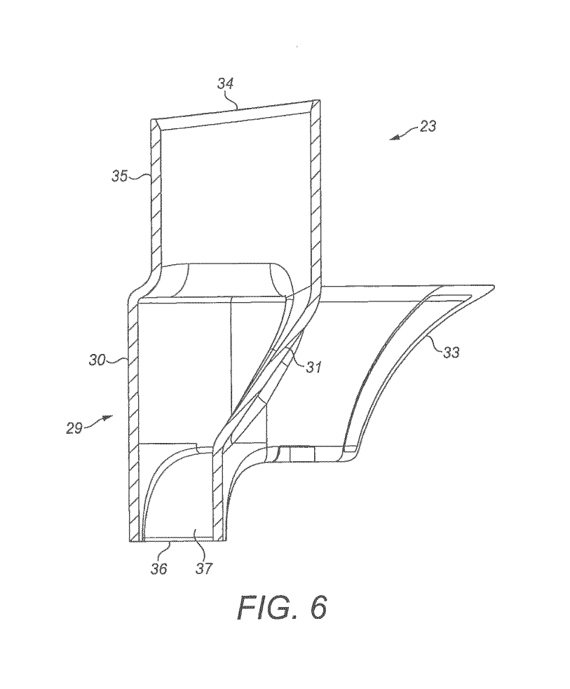

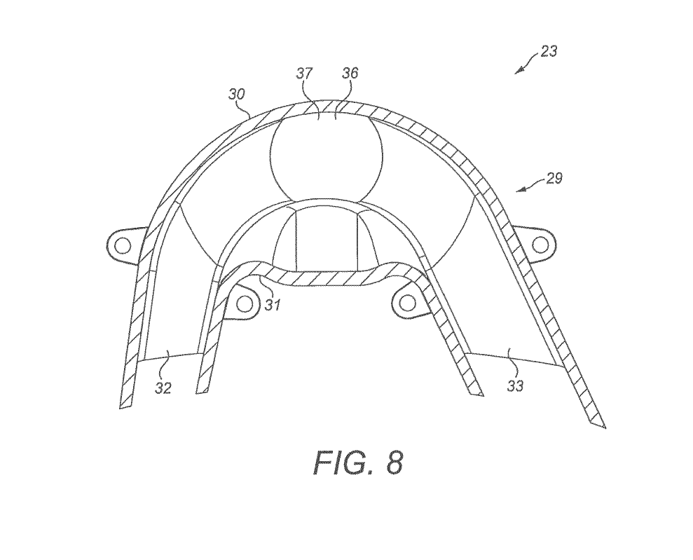

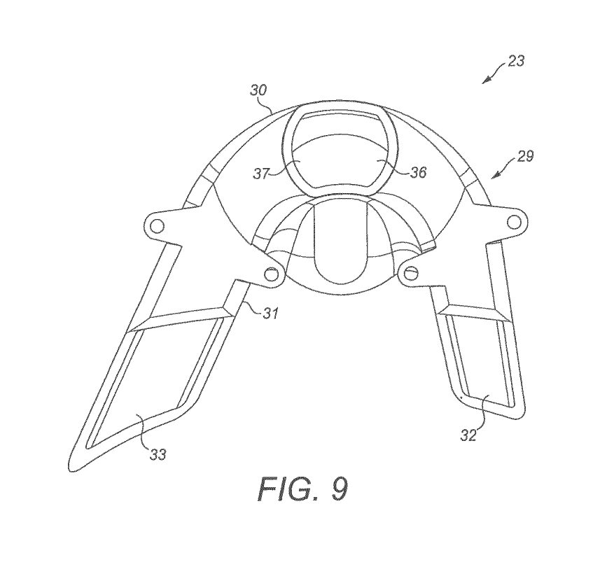

The exhaust device 23 is shown in more detail in FIGS. 3 to 9. The exhaust device 23 comprises an arcuately shaped or concave duct 29 having an outer peripheral wall 30 and an inner peripheral wall 31. The duct 29 includes an inlet 32 and a first outlet 33 both communicating with the cooking chamber 20 (as shown in FIG. 2). The inlet 32 is connected to the first aperture 21 of the upper enclosure 17 so that air can flow out of the cooking chamber 20 through the inlet 32. The first outlet 33 is connected to the second aperture 22 of the upper enclosure 17 so that air can flow back into the cooking chamber 20 through the fir st outlet 33. The exhaust device 23 is located in the vicinity of the fan 18 such that the fan 18 generates an airflow through the inlet 32 and the duct 29. Also, the respective cross sections of the inlet 32 and the first outlet 33 and their position relative to each other are chosen such that the air pressure at the first outlet 33 is less than the air pressure at the inlet 32, so that air flows from the cooking chamber 20 through the inlet 32, the duct 29, and through the first outlet 33 back to the cooking chamber 20. The arcuate shape of the duct 29 generates a centrifugal force within the duct 29 which is applied to solid and/or liquid particles contained in the air such that such solid and/or liquid particles are deviated and forced towards the outer peripheral wall 30 of the duct 29.

The duct 29 also comprises a second outlet 34 facing substantially upwardly and through which, in use, the volume of heated air flows to exit the cooker 1. The second outlet 34 comprises a tubular passage or channel 35 extending upwardly from the duct 29. The channel 35 extends substantially transversally to the duct 29. The channel 35 extends upwardly from a central region 29a of the duct 29 located between the inlet 32 and the first outlet 33. In the central region 29a, the inner peripheral wall 31 is angled such that the channel 35 has a cross-section which is large enough to provide an effective evacuation of the volume of heated air from the cooking chamber 20. Thus, the arcuate shape of the duct is generally in one plane (in particular horizontal in this example) and the second outlet is perpendicular to this plane (in particular vertical in this example).

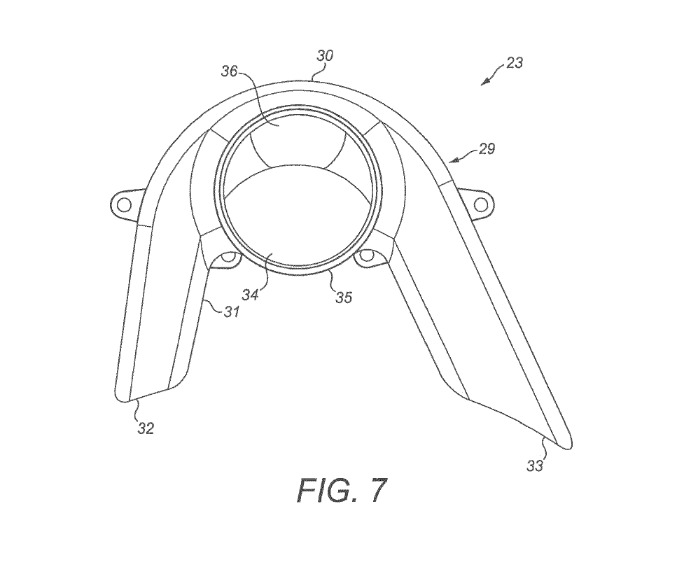

In the embodiment shown in FIGS. 3 to 9, the duct 29 further comprises a third outlet 36 facing substantially downwardly and through which, in use, at least some of the solid and/or liquid particles contained in the air flowing through the duct 29 are drawn by gravity. The third outlet 36 comprises a spout 37 extending substantially downwardly from the outer peripheral wall 30 of the duct 29. In the embodiment described herein, the spout 37 and the channel 35 are aligned with each other (as visible for example in FIG. 7). The spout 37 is arranged such that, in use, solid and/or liquid particles which are forced towards the outer peripheral wall 30 by the centrifugal force fall by gravity through the spout 37.

The cooker 1 further comprises a receptacle 38 (shown in FIG. 1) for receiving solid and/or liquid particles flowing through the spout 37. The receptacle 38 locates in the exhaust compartment 27, beneath the exhaust device 23. The receptacle 38 faces the third outlet 36. The receptacle 38 is removable from the cooker 1 so that the receptacle 38 can be emptied from solid and/or liquid particles received in the receptacle 38 after flowing through the third outlet 36.

In use, the outer pan 4 is removed from the housing 2 so that the food ingredients 8 can be introduced in the food container 5. Then, the outer pan 4 is placed again in the housing 2, beneath the upper enclosure 17. Upon start-up of the cooker 1, air is heated by means of the heater 19 and heated air is circulated in the cooking chamber 20 by means of the fan 18. The heated air is circulated at high velocity and allows for a high rate of heat transfer to the food ingredients 8, relative to a conventional oven. The circulation of the flow of heated air is illustrated by the arrows F in FIG. 1.

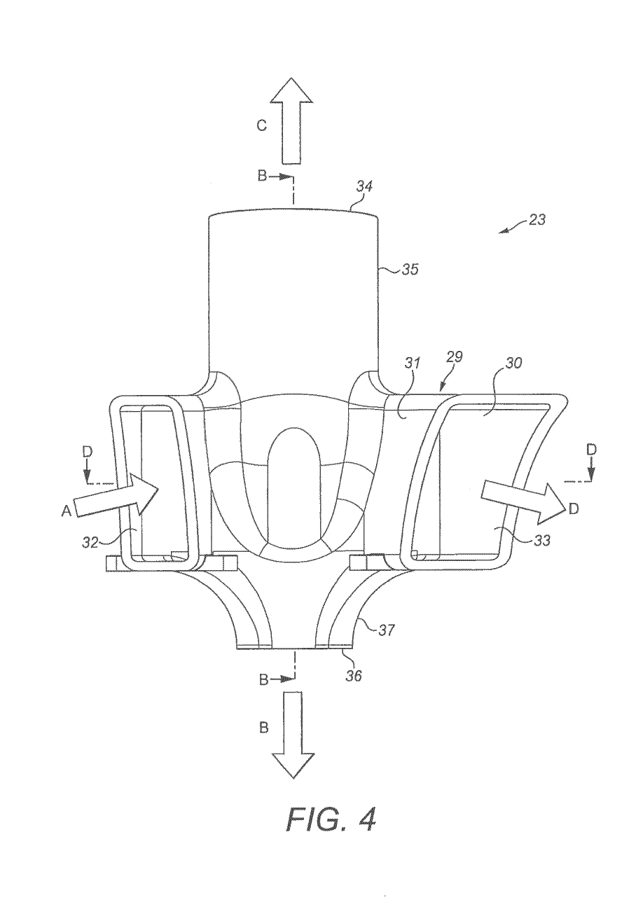

During the cooking of the food ingredients 8, a flow of heated air generated by the fan 18 in the cooking chamber 20 flows through the duct 29, via the first aperture 21 and the inlet 32, as shown by the arrow A in FIGS. 2 and 4. The flow of heated air may contain, for example, big or heavy food particles, such as food crumbs and/or oil drops, and lighter particles. While heated air flows in the duct 29, the centrifugal force produced by the arcuate shape of the duct 29 acts on these heavy food particles such that the heavy particles are forced or pushed towards the outer peripheral wall 30, whereas the lighter particles are not or less acted upon by the centrifugal force and remain spaced from the outer peripheral wall 30. While the particles contained in the air flow reach the central region 29a, the heavy food particles are drawn by gravity through the spout 37 extending from the outer peripheral wall 30, as shown by the arrow B in FIGS. 2 and 4, and fall into the receptacle 38. Because of their lighter weight, and because of the pressure and temperature difference between the duct 29 and the second outlet 34, the lighter particles flow upwards towards the channel 35, as shown by the arrow C in FIGS. 2 and 4, and towards the exhaust grille to exit the cooker 1. The remainder of the air flow is recirculated into the cooking chamber 20 through the first outlet 33, as shown by the arrow D in FIGS. 2 and 4. After use, the receptacle 38 can be removed from the housing 2 to be emptied and cleaned, and then placed again in the housing 2 for further use of the cooker 1.

The centrifugal force created by the arcuate shape of the duct 29 allows to separate heavy food particles from lighter particles in the exhaust air, and to collect these heavy food particles in the receptacle 38. This enables the amount of big or heavy particles exiting the cooker 1 through the exhaust grille to be limited, and therefore allows to reduce the pollution of the housing and/or the surroundings of the cooker 1. In other words, the exhaust device 23 according to the present invention filters the exhaust air so that the air exiting the cooker 1 is cleaner than in conventional air-based cookers. The shape of the duct 29 also allows to decrease the speed of the air exiting the cooker 1, which further helps to reduce the amount of food particles flowing out of the cooker 1. Moreover, the exhaust device 23 allows to regulate the pressure in the cooking chamber 20, which improves the performance of the cooker 1. In addition, the exhaust device 23 has a simple design which makes it easy to clean compared to exhaust systems used in conventional air-based cookers.

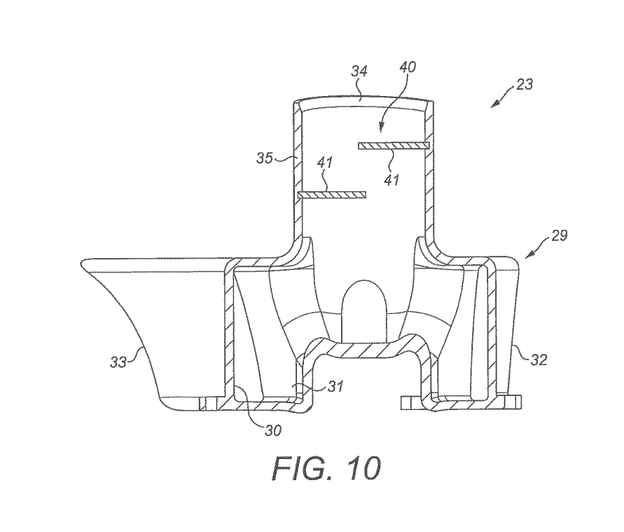

Referring now to FIG. 10, a variant of the cooker according to the first embodiment is shown, wherein like features retain the same reference numerals. Only the differences in relation to the cooker according to the first embodiment are described below.

In the variant described herein, the third outlet 36 is omitted, so that the heavy food particles, after being pushed towards the outer peripheral wall 30, are redirected towards the cooking chamber 20 through the first outlet 33. Therefore, no additional part such as a receptacle for receiving the particles is needed. The heavy food particles are kept inside the cooking chamber 20. This facilitates the use of the cooker 1. This also makes the cleaning of the cooker 1 easier, since no additional part such as a receptacle needs to be cleaned.

As shown in FIG. 10, a restriction 40 is provided in the channel 35. After reaching a certain speed, the heavy particles may have enough inertia to bounce off the outer peripheral wall 30 and exit the exhaust device 23 through the channel 35. The restriction 40 is provided to limit the amount of solid and/or liquid particles flowing out of the cooker 1 through the channel 35. As shown in FIG. 10, the restriction 40 comprises first and second baffles or plates 41 extending transversally to the direction of the airflow flowing through the channel 35. The first and second baffles 41 are spaced from each other in offset relation such that the first and second baffles 41 limit the amount of particles exiting the channel 35 whilst letting the air flowing through the channel 35.

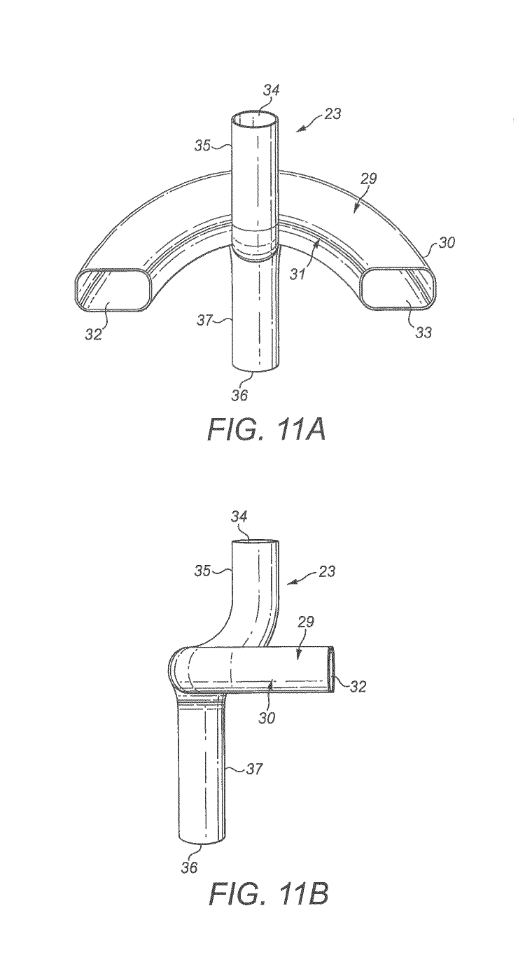

Referring now to FIGS. 11A and 11B, a second embodiment of the cooker according to the invention is shown, wherein like features retain the same reference numerals. Only the differences between the first and second embodiments are described below.

In the second embodiment, the channel 35 extends substantially upwardly from the inner peripheral wall 31 of the duct 29, whereas the position of the spout 37 is unchanged compared to the position of the spout 37 in the first embodiment and remains in line with the outer peripheral wall 30. Therefore, the channel 35 and the spout 37 are spaced from each other in offset relation. Therefore, in the second embodiment, the food particles which are forced towards the outer peripheral wall 30 by the centrifugal force are less likely to flow through the channel 35 than in an arrangement where the channel 35 and the spout 37 faces each other. The relative position of the channel 35 and the spout 37 therefore limits the amount of heavy food particles flowing out of the cooker 1 through the channel 35 and that may pollute the housing and/or surroundings of the cooker 1.

Although the present invention has been described in relation to an air-frying cooker, the invention can be used in any cooking appliance using a flow of heated air in a closed cooking chamber to cook food ingredients.

The above embodiments as described are only illustrative, and not intended to limit the technique approaches of the present invention. Although the present invention is described in details referring to the preferable embodiments, those skilled in the art will understand that the technique approaches of the present invention can be modified or equally displaced without departing from the scope of the invention as defined by the claims. In the claims, the word “comprising” does not exclude other elements or steps, and the indefinite article “a” or “an” does not exclude a plurality. Any reference signs in the claims should not be construed as limiting the scope.

1. An air-based cooker comprising:
a cooking chamber;
a heater for heating air in the cooking chamber;
a fan for circulating a flow of heated air in the cooking chamber;
an exhaust device for directing a volume of heated air out of the cooking chamber, the exhaust device comprising a duct including:
an inlet communicating with the cooking chamber;
a first outlet to the cooking chamber;
a second outlet through which, in use, the volume of heated air flows to exit the cooker;
wherein the duct is arcuately shaped with an outer peripheral wall and an inner peripheral wall such that, in use, a centrifugal force is applied to solid and/or liquid particles contained in the heated air flowing through the duct such that these particles are deviated and forced towards the outer peripheral wall, such as to limit the amount of solid and/or liquid particles flowing through the second outlet and exiting the cooker, and in that the second outlet faces substantially transversely to the duct.

2. An air-based cooker according to claim 1, wherein the exhaust device is arranged such that, in use, solid and/or liquid particles contained in the heated air flowing through the duct are redirected towards the cooking chamber through the first outlet.

3. An air-based cooker according to claim 1, wherein the duct comprises a third outlet facing substantially downwardly and through which, in use, at least some of the solid and/or liquid particles contained in the heated air flowing through the duct are drawn by gravity.

4. An air-based cooker according to claim 3, wherein the cooker comprises a receptacle for receiving solid and/or liquid particles flowing through the third outlet.

5. An air-based cooker according to claim 4, wherein the receptacle is removable from the cooker.

6. An air-based cooker according to claim 1, comprising a restriction in the second outlet adapted to further limit the amount of solid and/or liquid particles flowing out of the cooker through the second outlet.

7. An air-based cooker according to claim 6, wherein the restriction comprises one or more baffles located in the second outlet.

8. An air-based cooker according to claim 7, comprising two baffles spaced from each other in offset relation in the second outlet.

9. An air-based cooker according to claim 6, wherein the second outlet extends substantially upwardly from the inner peripheral wall of the duct.

10. An air-based cooker according to claim 6, wherein the second outlet extends substantially upwardly from the outer peripheral wall of the duct.

11. An air-based cooker according to claim 1, wherein the exhaust device and the fan are located relative to each other so that the fan generates an airflow through the duct.

12. An air-based cooker according to claim 1, wherein the second outlet faces substantially upwardly.

13. (canceled)

14. An air-based cooker according to claim 1, wherein the arcuate shape of the duct is generally in one plane and the second outlet is perpendicular to this plane.

15. An exhaust device for directing a volume of heated air out of an air-based cooker, the exhaust device comprising:
a duct
an inlet;
a first outlet;
a second outlet through which, in use, the volume of heated air flows to exit the cooker;
wherein the duct is generally arcuately shaped and has an outer peripheral wall and an inner peripheral wall such that, in use, a centrifugal force is applied to solid and/or liquid particles contained in the heated air flowing through the duct such that the particles are deviated and forced towards the outer peripheral wall, such as to limit the amount of solid and/or liquid particles flowing through the second outlet, and in that the second outlet faces substantially transversely to the duct.
